(19) United States
(12) Patent Application Publication
(10) Pub. No.: US 2010/0308035 A1
(43) Pub. Date: Dec. 9, 2010

(54) MICROWAVE OVEN WITH A DRAINAGE SYSTEM

(75) Inventors: Wuyong Zeng, Fujian Province (CN); Jin Li, Fujian Province (CN); Ting-Ba Lin, Taipei County (TW); Shangqian Gao, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/793,875

(22) Filed: Jun. 4, 2010

(30) Foreign Application Priority Data
Jun. 4, 2009 (CN) 200920138842.8

(51) Int. Cl. H05B 6/64

(52) U.S. Cl. 219/756

(57) ABSTRACT

The present invention provides a microwave oven with a drainage system. It comprises a chamber, a slip groove disposed on the bottom side of the chamber, a drain hole unit disposed in the slip groove, a rotary pan, a bracket unit provided with rolling wheel unit which can slip along the slip groove. The rolling wheel unit on the bracket unit can bring water to the drain hole unit, so that the water in the chamber flows out of the chamber soon in order to ensure that no water remains in the chamber to achieve a better cooking effect and facilitate operation of the microwave oven.

### Field of the invention

The present invention relates to a type of microwave oven.

### BACKGROUND OF THE INVENTION

As is known, when using microwave oven, there may be some water overflowing out of the container in the chamber. If water flows on the base of the chamber, cooking food will be interfered, and the microwave oven will need more washing. And if water flows into motor of driving rotary pan, the motor may be short-circuited to make the microwave oven out of use.

Therefore, some solutions are supplied by people, for example, the Chinese patent No. CN1217451A publishes an improved microwave oven with a drainage system. In the invention, a rotary pan is disposed under chamber for cooking, and a connector transport drive force of motor to the rotary pan. The water catchment of the base of the chamber for cooking has a trough, on which a first drain hole unit is disposed. A sloping-downward part on the motor bracket unit is lower than the first drain hole unit in order to prevent water from the first drain hole unit from flowing into the motor. A second drain hole unit is disposed in the sloping-downward part on the motor bracket unit. According to the invention, water from the water catchment of the base of the chamber for cooking flows through the first drain hole unit of the trough and flows out of the chamber for cooking, so when the microwave oven is working, water would not remain on the base the chamber for cooking, but is expelled out of the first drain hole unit and the second drain hole unit.

In above solution, a trough is disposed in the center of the water catchment and a sloping-downward part is disposed on the motor bracket unit in order to make the manufacturing process of the base of chamber and the motor bracket unit more complicated and make the manufacturing cost higher. Besides, water in the first drain hole unit and the second drain hole unit may spatter on the motor.

### SUMMARY OF THE INVENTION

The main purpose of the present invention is to overcome the disadvantages of the conventional technique, and to provide a microwave oven with a water drainage system, and it achieves a function of automatic drainage by reforming the slip groove.

The technical solution applied by the present invention is:

A microwave oven with a drainage system comprises:

a chamber for cooking;

a rotary pan disposed on the base of said chamber;

a bracket unit disposed on a slip groove for supporting said rotary pan on the base of said chamber and rotating along said slip groove with the rotary pan;

a motor pedestal mounted on the base of said chamber;

a motor disposed on said motor pedestal;

a rotating shaft for connecting said motor and said rotary pan;

and said bracket unit further comprises a rolling wheel unit which can be rolling in said slip groove, and said slip groove further comprises a drain hole unit disposed in or close to the rolling route of the rolling wheel unit.

In a preferred embodiment of the present invention, a water container is disposed under the base of said chamber, corresponding to said drain hole unit.

In a preferred embodiment of the present invention, said water container is in the shape of a funnel.

In a preferred embodiment of the present invention, said drain hole unit is disposed in a drain groove, and the drain groove is disposed in the slip groove of said chamber.

In a preferred embodiment of the present invention, said drain groove is disposed with a draw wall which is sloping inward and shrinking.

In a preferred embodiment of the present invention, said drain hole unit and said slip groove are made by once molding.

When the present invention is working, if there is water in the slip groove of said chamber, most of water may flow into said drain hole unit automatically, and because said rotary pan drives the bracket unit to rotate along said slip groove, said rolling wheel unit on the bracket unit of said rotary pan can bring remaining water into said drain hole unit in order to make sure that there is no water remaining said chamber for cooking.

From the above descriptions of the present invention, compared to the conventional technique, the microwave oven with a drainage system of the present invention has the following advantages:

1. In the present invention, drain hole unit is disposed in the slip groove of the chamber, and rolling wheel unit on the bracket unit is rotating along the slip groove of the chamber, and the drain hole unit is disposed in or close to the rolling route of the rolling wheel unit. And because the rotary pan drives the bracket unit to rotate, the rolling wheel unit on the bracket unit can bring remaining water in the slip groove of the chamber into the drain hole unit in order to make sure that there is no water remaining the chamber for cooking, as a result of better cooking effect and convenience of operation.

2. In the present invention, a water container is disposed under the base of the chamber in order to gather water from the drain hole unit and to prevent water from flowing anywhere else.

3. The water container is in the shape of a funnel in order to facilitate gathering water.

4. The drain hole unit are disposed in the drain groove in order to facilitate gathering water in the drain groove and expelling water out of the drain hole unit

5. A water draw wall, which is sloping inward and shrinking, is disposed around the drain groove in order to facilitate gathering water in the drain groove and expelling water out of the drain hole unit.

6. The drain hole unit and the slip groove are made by once molding.

### BRIEF DESCRIPTION OF THE DRAWINGS

FIG. 1 is a three-dimension exploded view of the present invention.

FIG. 2 is an enlarged view of part A in FIG. 1.

### DESCRIPTION OF SPECIFIC EMBODIMENTS

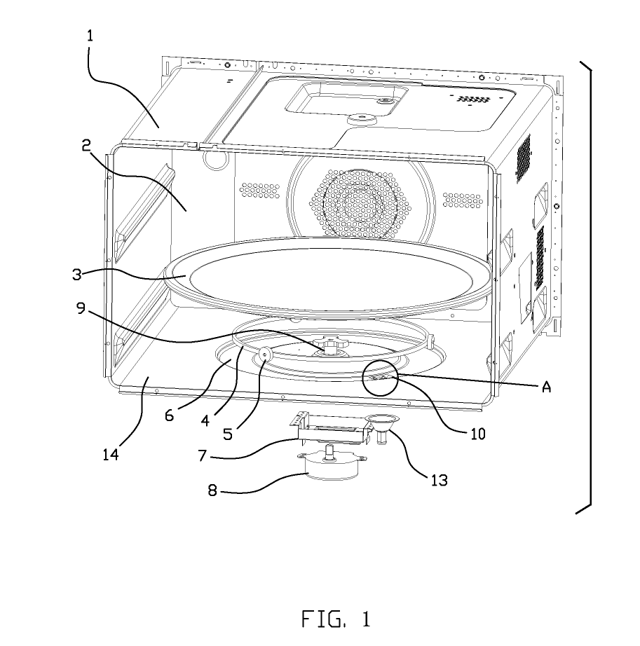

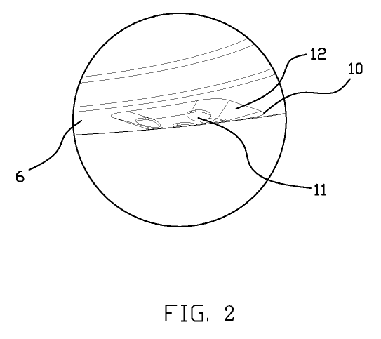

Referring to FIG. 1 and FIG. 2, the microwave oven with a drainage system of the present invention comprises: a chamber 1 forming a cooking room 2, a slip groove 6 of the chamber 1 disposed in the base 14 of the chamber 1 has, a bracket unit 4 of rotary pan disposed on the a slip groove 6, and rolling wheel unit 5 disposed on the bracket unit 4 supporting the rotary pan 3. And a motor 8 is disposed on the motor pedestal 7, and a pedestal 7 of the motor is mounted on the base 14 of the chamber 1. And the motor 8, which is connected to the rotary pan 3 by a rotating shaft 9, can drive the rotary pan 3 to rotate.

A drain groove 10 disposed in the slip groove 6 of the chamber is in or close to the route of the rolling wheel unit 5 in the slip groove 6 of the chamber. The upper opening of the drain groove 10 is large and the lower opening is small, which forms a water draw wall 12, and several drain hole unit 11 are disposed in the drain groove 10.

A funnel-shaped water container 13 is disposed under the base 14 of the chamber 1, corresponding to the drain groove 10.

If there is water in the slip groove 6 of the chamber, most of water will flow into the drain groove 10 and will be expelled from of the drain hole unit 11 into the water container 13, and because the rotary pan 3 drives the bracket unit 4 of the rotary pan to rotate, the rolling wheel unit 5 on the bracket unit 4 of the rotary pan can bring remaining water into the drain groove 10 in order to make sure that there is no water remaining the cooking room 2.

All above is just a preferred embodiment of the present invention, so the present invention should not be limited in these embodiments. In a word, it should be understood that according to the scope of the present invention and the content of the description, all the various equivalent modifications and alterations will be apparent in the scope and spirit of this invention. Therefore, the scope and sprit of the invention is limited only by the claims.

What is claimed is:

1. A microwave oven with a drainage system comprises:
a chamber for cooking;
a rotary pan disposed on the base of said chamber;
a bracket unit disposed on a slip groove for supporting said rotary pan on the base of said chamber and rotating along said slip groove with the rotary pan;
a motor pedestal mounted on the base of said chamber;
a motor disposed on said motor pedestal;
a rotating shaft for connecting said motor and said rotary pan;
wherein said bracket unit further comprises a rolling wheel unit which can be rolling in said slip groove, and said slip groove further comprises a drain hole unit disposed in or close to the rolling route of the rolling wheel unit.

2. The microwave oven with a drainage system according to claim 1, wherein a water container is disposed under the base of said chamber, corresponding to said drain hole unit.

3. The microwave oven with a drainage system according to claim 2, wherein said water container is in the shape of a funnel.

4. The microwave oven with a drainage system according to claim 1, wherein said drain hole unit is disposed in a drain groove, and the drain groove is disposed in the slip groove of said chamber.

5. The microwave oven with a drainage system according to claim 4, wherein said drain groove is disposed with a draw wall which is sloping inward and shrinking.

6. The microwave oven with a drainage system according to claim 1, wherein said drain hole unit and said slip groove are made by once molding.
